(19) United States
(12) Patent Application Publication
(10) Pub. No.: US 2005/0166077 A1
(43) Pub. Date: Jul. 28, 2005

(54) Method for reactivating an autonomous computer

(76) Inventor: Olivier Reisacher, Biviers (FR)

Correspondence Address: PERMAN & GREEN, 425 POST ROAD, FAIRFIELD, CT, 06824, US

(21) Appl. No.: 10/941,758

(22) Filed: Sep. 15, 2004

(30) Foreign Application Priority Data
Dec. 31, 2003 (FR) 03 51241

(51) Int. Cl. G06F 1/30; G06F 1/32

(52) U.S. Cl. 713/320

(57) ABSTRACT

To achieve optimum energy savings in a laptop computer and to manage its mobility with the utmost efficiency, a standby mode is planned for this laptop. In this standby mode, a telecommunications card remains in a state of listening to short messages if any. Depending on the short message received, the telecommunications card reactivates (i.e. awakens) or does not reactivate the laptop. If the computer is reactivated, it performs the instructions contained in the short message. It then becomes possible to push the information into a laptop FIG. 3.

### BACKGROUND OF THE INVENTION

1. Field of the Invention

An object of the invention is a method for awakening or reactivating an autonomous computer. The field of the invention is that of telecommunications. More particularly, the field of the invention is that of information pushing. “Pushing” is the recording of data on an apparatus where the recording is remote-controlled without action by the user of the apparatus or without any request from the apparatus for reception of the data. In this case, it is said that a piece of information is “pushed” into an apparatus. It is also said that data is “uploaded” into the apparatus. More particularly again, the field of the invention is that of energy savings for autonomous computers.

The term “autonomous computer” is understood to mean a computer whose only energy source is a battery. In particular, such a computer is not connected to the mains system for its power supply. The most classic case of an autonomous computer is what called a laptop computer or laptop

A laptop has a large number of electronic components, a powerful processor, a large-sized screen, random-access memories, hard disk drives, various and varied media readers (such as CD-ROM, DVD, floppy, flash compact card and other readers) which make an apparatus of this kind a heavy consumer of electrical energy. In order to preserve their autonomy to the maximum extent, these autonomous computers are put on standby at the least occasion. In this mode all the components, except for the random-access memory, are turned off. Preserving the contents of the random-access memory makes for faster re-starting or coming out of standby mode.

The passage into standby mode is automatic. As soon as the laptop detects inactivity, it goes automatically into this mode in order to consume minimum energy and hence save energy. Bringing the laptop out of this standby mode is, on the contrary, at the discretion of the laptop user. Coming out of standby mode can be likened to a restarting of the laptop. There is therefore considerable lapse of time between the start of the reactivation and the effective availability of the computer.

In practice, when the user of a computer wishes to access a piece of information that is online, i.e. a piece of information that is not directly on his computer but has to be downloaded, he must start up his laptop, then establish a connection with the network. Only then can he concern himself with the piece of information that interests him. In this document, a piece of information may range from an e-mail message to an update or an audio file. A piece of information is therefore a digital content corresponding to one or more files which may or may not be structured.

The user of a laptop therefore faces at least two difficulties when he wishes to obtain a piece of information from a location external to his laptop. The first is that he has to wait for the laptop to be reactivated. The second is that he has to set up a connection with the network, and only then will he be able to access said external information. A piece of external information is considered here to be one that is not recorded in an internal memory of the computer.

The latter difficulty arises out of the nature of the laptop whereby it is mobile. Such a laptop therefore cannot be permanently connected to a data network such as the Internet, a LAN (Local Area Network) or the like, unlike an office computer connected to said network through a physical Ethernet interface. Such an interface corresponds to a cable connection. This impossibility of permanent connection can be explained by at least two reasons. The first is the energy consumption required to maintain this permanent connection. The second is the cost of maintaining a GPRS type aerial connection for example.

2. Description of the Prior Art

In the prior art, a laptop user wishing to obtain a piece of external information must therefore reactivate his laptop, set up a connection in data mode and search for said piece of information, hoping that it will be accessible. Once the information is found, he still has to be patient during the information downloading time which may vary according to the size of the information to be downloaded.

The invention resolves these problems on laptops provided with communications cards according to a mobile communications standard belonging to a generation more advanced than the second generation or equal to the second generation. Thus, this type of card works according to the GSM, GPRS, or UMTS standards. It is possible in this case, for example, to send a short message to the communications cards. This short message comprises an instruction code used to identify an action that has to be performed by the laptop. If this action corresponds to information retrieval, then the short message also has an identifier of the information to be retrieved. Once this short message has been received, the communications card reactivates the laptop which may then retrieve the information without any action by the user.

With the method of the invention, it therefore becomes possible to retrieve a piece of information in an optimal way, i.e. without any waiting period or without any request or call from the user. The method according to the invention minimizes the number of retrieval attempts, actually reducing the number to one attempt. The method of the invention minimizes the information retrieval time because, firstly, the computer possesses all the information necessary for the retrieval of the information and, secondly, the method does not require any human intervention liable to slow down the laptop. At the end of the retrieval, the computer returns to its initial state, i.e. a standby state.

In one variant, this retrieval is done with the screen off, thus providing for retrieval at low cost in energy. Ultimately, it is even possible to conceive of a situation where all the components of the computer are turned off except for the communications card which acts autonomously and will retrieve the data. The data retrieved by the card will be transferred to the laptop at the very first reactivation of the laptop by the user.

### SUMMARY OF THE INVENTION

An object of the invention therefore is a method for reactivating an autonomous computer comprising a wireless connection device wherein:
the wireless connection device receives, through an aerial, a reactivation message comprising at least one field comprising at least one instruction code,
the wireless connection device analyses the reactivation message received to determine whether there are grounds for reactivating the autonomous computer,
if necessary:

the wireless connection device reactivates the autonomous computer,
the wireless connection device transmits the received message to the autonomous computer,
the autonomous computer performs the operations corresponding to at least the instruction code of at least the field of the activation message.

Advantageously, the invention is also characterized by the fact that the reactivation message is of the short-message type according to the standards of mobile communications.

Advantageously, the invention is also characterized by the fact that:
the instruction code corresponds to an instruction to download a digital content,
the short message comprises an identifier of content of the digital content,
once the autonomous computer has been reactivated by the wireless connection device, it sets up a connection in data mode with a telecommunications network to download the digital content identified by the content identifier.

Advantageously, the invention is also characterized by the fact that the connection in data mode is set up through the wireless connection device.

Advantageously, the invention is also characterized by the fact that the connection in data mode is set up through a second interface different from the wireless connection device that has enabled the reception of the reactivation message.

Advantageously, the invention is also characterized by the fact that:
the instruction code corresponds to an instruction to download a digital content,
the short message comprises an identifier of content of the digital content,
the wireless connection device sets up a connection in data mode for the downloading, into a content memory that it contains, of the digital content identified by the content identifier.

Advantageously, the invention is also characterized by the fact that:
the wireless connection device reactivates the autonomous computer,
the autonomous computer retrieves the content from the content memory of the wireless connection device.

Advantageously, the invention is also characterized by the fact that:
a user of the autonomous computer initiates the reactivation of this computer,
the autonomous computer retrieves the content from the content memory of the wireless connection device.

Advantageously, the invention is also characterized by the fact that once the operations corresponding to at least the instruction code of at least the field of the reactivation message have been performed, the computer returns to a standby mode.

Advantageously, the invention is also characterized by the fact that the reactivation message comprises at least one field comprising at least one piece of information to authenticate the sender of the reactivation message, the processing of the instruction code being then conditioned by the acceptance of the piece of authenticating information by the autonomous computer.

Advantageously, the invention is also characterized by the fact that the reactivation of the autonomous computer is partial and that its screen is not activated.

Advantageously, the invention is also characterized by the fact that, prior to the interpretation of the instruction code of the reactivation message, the wireless connection device analyses the state of the network.

### BRIEF DESCRIPTION OF THE DRAWINGS

The invention will be understood more clearly from the following description and the accompanying figures. These figures are given by way of an indication and in no way restrict the scope of the invention. Of these figures:

FIG. 1 illustrates means to implement the invention.

FIG. 2 illustrates a communications card implementing the method according to the invention.

FIG. 3 illustrates steps of the method according to the invention.

FIG. 4 illustrates steps of a variant of the method according to the invention.

### MORE DETAILED DESCRIPTION

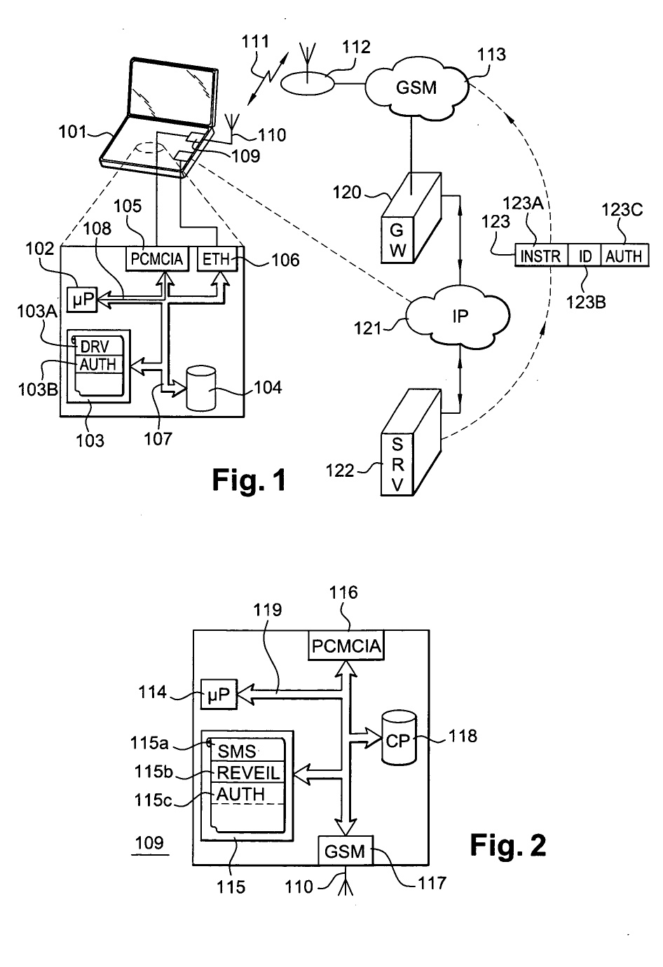

FIG. 1 shows an autonomous computer 101. In practice, this is a computer called a laptop, whose only power source is a battery (not shown). The computer 101 comprises a microprocessor 102, a program memory 103, a storage memory 104, a PCMCIA type connection interface 105 and, in one variant, an Ethernet type connection interface 106. The elements 102 to 106 are connected through a bus 107. The bus 107 comprises especially a wire or track 108 to convey an interruption signal produced by the interface 105. A PCMCIA type interface must be understood to be an interface enabling the connection of an extension peripheral to the computer 101. In this field, backplane buses (ISA, PCI, etc.) and external ports (USB, RS232, etc.) are known.

In general, in this description, when an action is attributed to an apparatus, it is performed by a microprocessor of the apparatus controlled by an instruction code recorded in a program memory of the apparatus.

The PCMCIA interface 105 connects a communications card 109 to the computer 101. For the invention, this is a card of the communications card type on a mobile communications network such as, for example, the GSM, GPRS or UMTS networks. This card is an example of a wireless connection device.

The card 109 therefore has firstly a PCMCIA interface to communicate with a computer 101, and an aerial 110 to set up a wireless link 111 with a base station 112 of the mobile telecommunications network 113. A card such as the card 109 is known as a GSM modem card or a GPRS modem card.

FIG. 2 shows that the card 109 has a microprocessor 114, a program memory 115, a PCMCIA type interface 116, a telecommunications interface 118 connected to the aerial 110 and, in one variant, a storage memory 118. The elements 114 to 118 are connected through a bus 119. The interfaces 105 and 116 work together so that the computer can communicate with the card 109.

The memory 103 has a zone 103a comprising instruction codes by which the computer 101 can communicate with the card 109 through the interface 105. These instruction codes are known as pilots or drivers. The memory 103, in one variant, also has instruction codes to authenticate a message.

The memory 115 has a zone 115a comprising instruction codes by which the card 109 can receive short messages.

A short message is also known as an SMS (Short Message Service) message. A message of the short message type is therefore similar to the SMS message. It includes at least MMS (Multimedia Message Service) type messages and, more generally, messages that can be pushed to a mobile communications device working according to communications standards of the second generation (GSM), second-and-a-half generation or 2.5G (GPRS), third generation (UMTS), and future generations. Here, only short messages are being referred to. However, the method can be extended to the use of data connections or even ultimately to the use of signaling elements offered by mobile telephony networks.

The memory 115 also has a zone 115b comprising instruction codes to reactivate the computer 101. In one variant, the memory 115 has a zone 115c comprising instruction codes to authenticate a message.

FIG. 1 also shows that the network 113 has a gateway 120 between the GSM type telecommunications (closed) network 113 and an Internet type (open) network 121. FIG. 1 also shows a server 122 that is firstly connected to the network 121, and secondly comprises means to send a short message 123 to the card 109 through the network 113. In practice, the server 122 too has a modem card by which it can send short messages. The server 122 can also be directly connected to the operator's mobile telephony network without using any modem card.

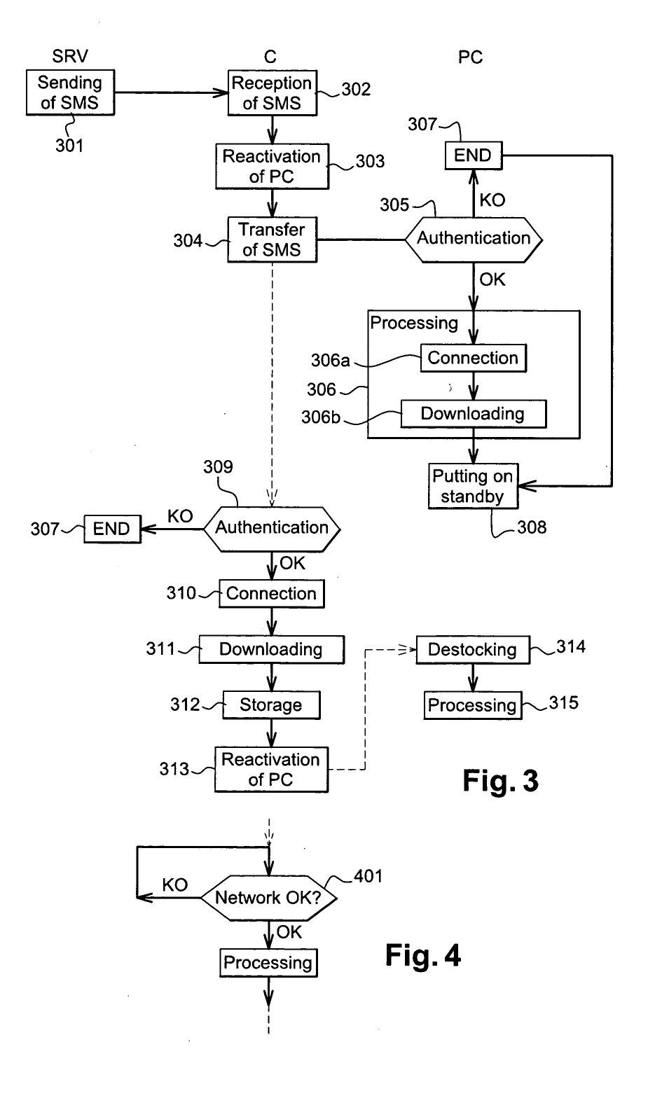

FIG. 3 shows that, in a preliminary step 301, the server 122 sends a short message 123 to the card 109. The computer 101 is considered at this time to be on standby. This means that all its components are off.

In order to be able to receive short messages, the card 109 is therefore identified on the network 113. This identification is done by an MSISDN number, namely a telephone number. The card 109 therefore contains a SIM card. It can be noted that one variant of the invention uses a mobile telephone instead of the card 109. This mobile telephone is then connected to the computer 101 and serves as a modem. In the invention, the card 109 (or the equivalent mobile telephone) is therefore constantly powered so as to be capable of receiving an SMS message. In mobile telephony, energy consumption problems, which are smaller than in the field of computers, are perfectly well controlled. This variant of the method using a mobile telephone instead of a card has a number of advantages. Indeed, the mobile telephone then acts as a communications card and there is a local connection between the mobile telephone and the laptop. This connection is, for example, an infrared, cable, radio or other similar connection. The main advantage of this variant is that, since the mobile telephone is almost always switched on, it retrieves data in a manner that is transparent for the user. This data is then stored in the mobile telephone and may be transferred automatically to the laptop during the first reactivation initiated by the user. Indeed, a laptop consumes far more energy than a mobile telephone, and therefore keeps going for shorter periods although it has a bulkier battery. Thus, the fact of permanently maintaining the power supply to the card 109 is not detrimental to the autonomy of the computer 101, since this card consumes very little energy.

In the invention, a computer in standby mode therefore maintains the power supply to the card 109. The card then shows consumption comparable to that of the computer in standby mode.

From the step 301, the invention passes to a step 302 for the reception of the short message 123 by the card 109. In this step, the card 109 records the message 123, for example in the memory 118. In a preferred variant, the card 109 performs a first analysis of the message 123 to decide on the reactivation of the computer. This first analysis is made, for example, on the structure of the message 123 and the content of the field that it contains. If the structure is not right, or if the fields are not properly formatted, then the short message is ignored.

In the step 303, the card 109 sends an interruption signal through the interfaces 116 and 105, and the track 108. This interruption is intercepted by an interruption controller of the microprocessor 102. In practice, the interruption controllers are among the only elements of a laptop that remain powered when it is in standby mode. Indeed, the laptop gets reactivated following a call or request from its user through a keyboard or a cursor device. For the microprocessor 102, this call takes the form of an interruption.

In the step 303, the microprocessor 102 therefore receives the interruption sent by the card 109. The microprocessor 102 knows that this interruption comes from the card 109 because it is conveyed by the predefined track 108 of the bus 107. The microprocessor then uses instruction codes of the zone 103a to process this interruption.

In a preferred example, this processing consists of a partial reactivation of the computer 101. This reactivation is partial because the screen of the computer 101 does not have to be lit up for the computer to process the short message. In the step 303, the computer 101 is therefore reactivated except for its screen. In one variant, it is also possible to supply power to the screen thus, for example, drawing the attention of the user who may then track the activity of the computer 101 on this screen.

Once the computer 101 has been reactivated, the invention passes to a step 304 in which the card 109 transmits the message 123 received at the step 302 to the computer 101.

FIG. 1 shows that the message 123 has a field 123a comprising an instruction code, a field 123b comprising an identifier of a piece of information and, in one variant, a field 123c comprising authentication data.

From the step 304, the invention passes to an optional step 305 for the authentication of the message 123. In this step, the computer 101 uses the data of the field 123c to authenticate the message 123. This authentication consists in determining the source of the message so as to compare the source with a list of senders authorized to send such messages to the computer 101. From this viewpoint, the content of the field 123c may simply be a telephone number of the sender, an IP address, a mail address, or any other piece of data enabling the identification of a person. In a more sophisticated variant, the authentication data is a digital signature using asymmetrical enciphering technologies and especially certificates delivered by certification authorities. In this variant, it becomes almost impossible to usurp an identity and send “malicious” messages.

The step 305 thus counters malicious acts as well as unsolicited mail.

Once the authentication data has been obtained, the computer 101 verifies that the sender thus authenticated is entitled to send this type of message to the computer 101. This verification is done, for example, by scanning an authorization table associating authentication data with rights. If the result of the authentication is positive, i.e. if the authenticated sender is authorized to send the message 123 to the computer 101, then the invention passes to a processing step 306. If not, it passes to an end step 307 in which the computer 101 erases the message 123 from its memory, and then passes to a step 308 for putting the computer to sleep.

In the step 308, the computer returns to the mode in which it had been before it was called at the step 303 by the card 109.

In the step 306, the computer reads the content of the field 123a to determine which action must be undertaken following the reception of the message 123. The processing is therefore an interpretation of the instruction code or codes contained in the message received at the step 302. In the present example, this processing is deemed to be the retrieval of a piece of information on the Internet server 122. In practice, this piece of information may be considered to be a file to be downloaded.

In one variant, the field 123a contains several instruction codes that have to be executed by the computer 101. For example, it may be a code to retrieve a piece of information that is an updating program which then has to be executed. It is also possible that the retrieved information is a request asking for other pieces of information to be sent from the computer 101. It is also possible that the message 123 is itself a request asking for information to be sent from the computer 101.

The step 306 comprises a sub-step 306a for setting up a connection on the Internet. This connection is a connection in data mode enabling the card 109 to access the network 121 through the network 113 and the gateway 120. Such a connection is known as a GSM connection data mode, a GPRS connection, or any other type of connection in data mode existing in mobile telecommunications networks. Here, the term “data mode” is used to distinguish it from the voice, signaling or standby modes.

In the step 306a, the card 109, controlled by the computer 101, comes out of its standby mode to enter an active mode by which it can set up a connection in data mode through the network 113.

From the step 306a, the invention passes to an information-retrieval step 306b. In the step 306b, the computer 101 uses the content of the field 123b as well as the connection made at the step 306a to retrieve the information identified by the content of the field 123b. In a preferred example, the field 123b comprises a URL (Universal Resource Locator) to identify all the resources, or pieces of information, available on the Internet. A well-formed URL indeed specifies a protocol, an identifier of a server and an identifier of a resource on this server.

With this method, the computer 101 is therefore able to retrieve any piece of information available on the Internet.

Once the information retrieval, also known as downloading, is finished, the invention passes the step 308.

At the next activation of the computer 101 following a call by a user, this user will have the information retrieved at the step 306b and directly available in the memory 104 of the computer 101. There is therefore no longer any human manipulation or period of waiting for a connection, or a search to obtain this information.

In one variant of the invention, the message 123 is used to warn the computer 101 that new electronic messages have arrived at the user's account and that they have to be retrieved. This releases the computer 101 from the task of having to interrogate the account regularly.

In one variant of the invention, the message 123 is used to retrieve and install updates of software installed in the computer 101.

FIG. 3 also illustrates a variant of the invention in which steps 309, 310 and 311, identical to the steps 305, 306a and 306b, are implemented by the card 109 without there being any need to reactivate the computer 101. In this variant, the invention passes from the step 302 to the step 309. It can be seen that, in this variant, the steps described may also be implemented by a mobile telephone capable of being locally connected to the laptop 101. In this example, the mobile telephone acts as a modem.

In this variant, the invention passes from the step 311 to a step 312 in which the card 109 records the information retrieved in the memory 118.

From the step 312 the invention passes to a step 313 for reactivating the computer 101. This reactivation is due either to an action by the user of the computer 101, or an action by the card 109 at the end of the storage step 312.

From the step 313, the invention passes to a destocking step 314 in which the computer 101 retrieves, from the memory 118, the information retrieved at the step 311 by the card 109.

Then, in a step 315, the computer 101 processes the information retrieved at the step 314 on the basis of action by the user and/or the instruction codes of the field 123a.

In this variant, the computer is not reactivated to perform the downloading. This provides for additional energy saving. On being reactivated, the computer 101 accesses the information retrieved in the memory 118. In practice, this memory is perceived by the computer 101 as a local hard disk drive. The retrieval from the memory 118 is either very fast or unnecessary because the computer 101 can directly exploit the retrieved information in the memory 118.

FIG. 4 shows a variant of the invention in which a step 401 for the analysis of the network follows the step 305 or the step 309. In the step 301, the wireless connection device analyses the state of the telecommunications network to which it is connected so as to determine whether it would be relevant to carry out the processing operation described by the message received at the step 302. This analysis is, for example, a measurement of the real bit rate of the network. This measurement is then compared with the theoretical bit rate. If the real bit rate measured is excessively below the theoretical bit rate, for example half of it, then the processing operation described by the message received at the step 302 is not performed because the conditions are not favorable.

It is possible to implement the other criteria of relevance such as for example a minimum real bit rate, a maximum computed duration of retrieval and a maximum computed retrieval cost. If we know the size of the file to be retrieved and the real cost, it is indeed possible to estimate the time and cost of retrieval. In this variant, either the message received at the step 302 comprises a description of the file to be retrieved, or the device obtains a description of it before performing the processing operation described. It is also possible to base the relevance criterion solely on the real bit rate. In certain cases, it is also possible that the cost of the communications will vary as a function of the localization and the date. In these cases, the analysis of the network takes account of it, if necessary to postpone the processing described to a date and/or to a location of the laptop 101 that is more favorable. These criteria of relevance may be used singly or all together in combination or again in a combination of only some of them.

In the variant of FIG. 4, the wireless connection device assesses a relevance criterion and so long as this relevance criterion is not met, the processing described by the message received at the step 302 is not performed. As soon as the relevance criterion is met, the invention passes from the step 401 to the processing steps.

In another variant of the invention, the message 123 specifies an interface to retrieve information. This interface is for example the Ethernet interface 106. In this variant, the computer 105 receives a short message through the interface 105 and the card 109 to retrieve information through the interface 106. This retrieval will be done when the computer 101 is connected to a local wire network, and probably to the mains supply system. Even more advantageously, the laptop, the card or the mobile telephone will wait in order to automatically detect that it is in a region covered by a mobile network with a higher bit rate and/or operating at lower cost (for example a WLAN network) before initiating the downloading of data. The utility of this variant is that a greater volume of information, namely very big files, can be retrieved. Indeed, such files require substantial bandwidth, and/or extended periods of autonomy because the retrieval time may be lengthy. For a connection to a mobile telecommunications network, a file is considered to be very big, i.e. upwards of five megabytes.

The invention therefore provides for the management of the autonomy and mobility of an autonomous computer with the utmost efficiency and with high flexibility.

1. A method for reactivating an autonomous computer comprising a wireless connection device wherein:
the wireless connection device receives, through an aerial, a reactivation message comprising at least one field comprising at least one instruction code,
the wireless connection device analyses the reactivation message received to determine whether there are grounds for reactivating the autonomous computer,
if necessary:
the wireless connection device reactivates the autonomous computer,
the autonomous computer performs the operations corresponding to at least the instruction code of at least the field of the activation message.

2. A method according to claim 1, wherein the reactivation message is of the short-message type according to the standards of mobile communications.

3. A method according to claim 1, wherein:
the instruction code corresponds to an instruction to download a digital content,
the short message comprises an identifier of content of the digital content,
once the autonomous computer has been reactivated by the wireless connection device, it sets up a connection in data mode with a telecommunications network to download the digital content identifier by the content identifier.

4. A method according to claim 3, wherein the connection in data mode is set up through the wireless connection device.

5. A method according to claim 3, wherein the connection in data mode is set up through a second interface different from the wireless connection device that has enabled the reception of the reactivation message.

6. A method according to claim 1, wherein:
the instruction code corresponds to an instruction to download a digital content,
the short message comprises an identifier of content of the digital content,
the wireless connection device sets up a connection in data mode for the downloading, into a content memory that it contains, of the digital content identified by the content identifier.

7. A method according to claim 6 wherein:
the wireless connection device reactivates the autonomous computer,
the autonomous computer retrieves the content from the content memory of the wireless connection device.

8. A method according to claim 6 wherein:
a user of the autonomous computer initiates the reactivation of this computer,
the autonomous computer retrieves the content from the content memory of the wireless connection device.

9. A method according to claim 1 wherein, once the operations corresponding to at least the instruction code of at least the field of the reactivation message have been performed, the computer returns to at standby mode.

10. A method according to claim 1, wherein reactivation message comprises at least one field comprising at least one piece of information to authenticate the sender of the reactivation message, the processing of the instruction code being then conditioned by the acceptance of the piece of authenticating information by the autonomous computer.

11. A method according to claim 1, wherein the reactivation of the autonomous computer is partial.

12. A method according to claim 1 wherein, prior to the interpretation of the instruction code of the reactivation message, the wireless connection device analyses the state of the network.
